(19) United States
(12) Patent Application Publication
(10) Pub. No.: US 2019/0333252 A1
(43) Pub. Date: Oct. 31, 2019

(54) DISPLAY CONTROL DEVICE, DISPLAY SYSTEM, AND DISPLAY CONTROL METHOD

(71) Applicant: Mitsubishi Electric Corporation, Tokyo (JP)

(72) Inventor: Atsushi MAEDA, Tokyo (JP)

(73) Assignee: Mitsubishi Electric Corporation, Tokyo (JP)

(21) Appl. No.: 16/344,743

(22) PCT Filed: Dec. 7, 2016
(86) PCT No.: PCT/JP2016/086367

§ 371 Date: Apr. 24, 2019

(51) Int. Cl. G06T 11/00; G06T 3/20; B60R 1/00; B60R 11/04

(52) U.S. Cl. CPC G06T 11/00; G06T 3/20; B60R 2011/004; B60R 11/04; B60R 2300/205; B60R 1/00

(57) ABSTRACT

A traveling direction acquiring unit acquires change information of the traveling direction of a vehicle output by a traveling direction detecting unit. An image synthesizing unit synthesizes an image capturing the front view from the vehicle and an image capturing, out of the right rear side view and the left rear side view from the vehicle, a rear side view in a direction after a change indicated by the change information. A display control unit outputs, to a projecting unit, a control signal for projecting the image synthesized by the image synthesizing unit in a front view in the direction after the change indicated by the change information, the front view being one of the right front view and the left front view as viewed from a driver.

### TECHNICAL FIELD

The present invention relates to a device which controls a process of providing an image capturing surroundings of a vehicle to a driver.

### BACKGROUND ART

A system is known in which side mirrors are provided electrically by displaying, on the instrument panel or the like, images obtained by photographing the right rear side view and the left rear side view from a vehicle by in-vehicle imaging units.

For example, Patent Literature 1 describes a display control device for displaying, on a side glass, a display image based on images of left and right rear views photographed from a moving body. There are cases where pedestrians or other objects are present ahead of a vehicle; however by displaying an image on a side glass instead of on the windshield as described in Patent Literature 1, a driver can confirm the front view from the vehicle without being blocked by the display image.

### CITATION LIST

### Patent Literature

Patent Literature 1: JP 2015-174643 A

### SUMMARY OF INVENTION

### Technical Problem

However, when the display is on a side glass as described in Patent Literature 1, the movement of the driver's line of sight for confirming the display is large.

The present invention has been devised in order to solve the problem as described above, and it is an object of the present invention to provide a display control device that allows a driver to confirm the right rear side view or the left rear side view from a vehicle without a large amount of movement of the line of sight and to confirm the front view from the vehicle as well.

### Solution to Problem

A display control device according to the present invention includes: an image acquiring unit for acquiring images capturing surroundings of a vehicle; a traveling direction acquiring unit for acquiring change information of a traveling direction of the vehicle; an image synthesizing unit for synthesizing an image capturing a front view from the vehicle and an image capturing a rear side view in a direction after a change indicated by the change information, the rear side view being one of a right rear side view and a left rear side view from the vehicle; and a display control unit for outputting a control signal for projecting an image synthesized by the image synthesizing unit in a front view in the direction after the change indicated by the change information, the front view being one of a right front view and a left front view as viewed from a driver.

### Advantageous Effects of Invention

According to the present invention, it is possible to control so that an image obtained by synthesizing an image capturing the front view from the vehicle and an image capturing a rear side view in a direction after a change indicated by the change information, out of the right rear side view and the left rear side view from the vehicle, is projected in a front view in the direction after the change indicated by the change information out of the right front view and the left front view as viewed from the driver. Thus, the driver can confirm the right rear side view or the left rear side view from the vehicle without a large amount of movement of the line of sight and confirm the front view from the vehicle as well.

### BRIEF DESCRIPTION OF DRAWINGS

FIG. 1 is a block diagram illustrating a configuration of a display control device according to a first embodiment of the present invention.

FIG. 2 is a diagram illustrating exemplary installation of imaging units.

FIGS. 3A and 3B are diagrams illustrating exemplary hardware configurations of the display control device according to the first embodiment of the present invention.

FIG. 4 is a flowchart illustrating exemplary processing performed by the display control device according to the first embodiment of the present invention.

FIG. 5 is an overhead view illustrating an example of a vehicle and surroundings thereof.

FIG. 6 is a diagram illustrating an image projected by a projecting unit under the situation illustrated in FIG. 5.

FIG. 7 is a block diagram illustrating a configuration of a display control device according to a second embodiment of the present invention.

FIG. 8 is a flowchart illustrating exemplary processing performed by the display control device according to the second embodiment of the present invention.

FIG. 9 is an overhead view illustrating an example of a vehicle and surroundings thereof.

FIG. 10 is a diagram illustrating an image projected by a projecting unit under the situation illustrated in FIG. 9.

### DESCRIPTION OF EMBODIMENTS

To describe the present invention further in detail, embodiments for carrying out the present invention will be described below with reference to the accompanying drawings.

### First Embodiment

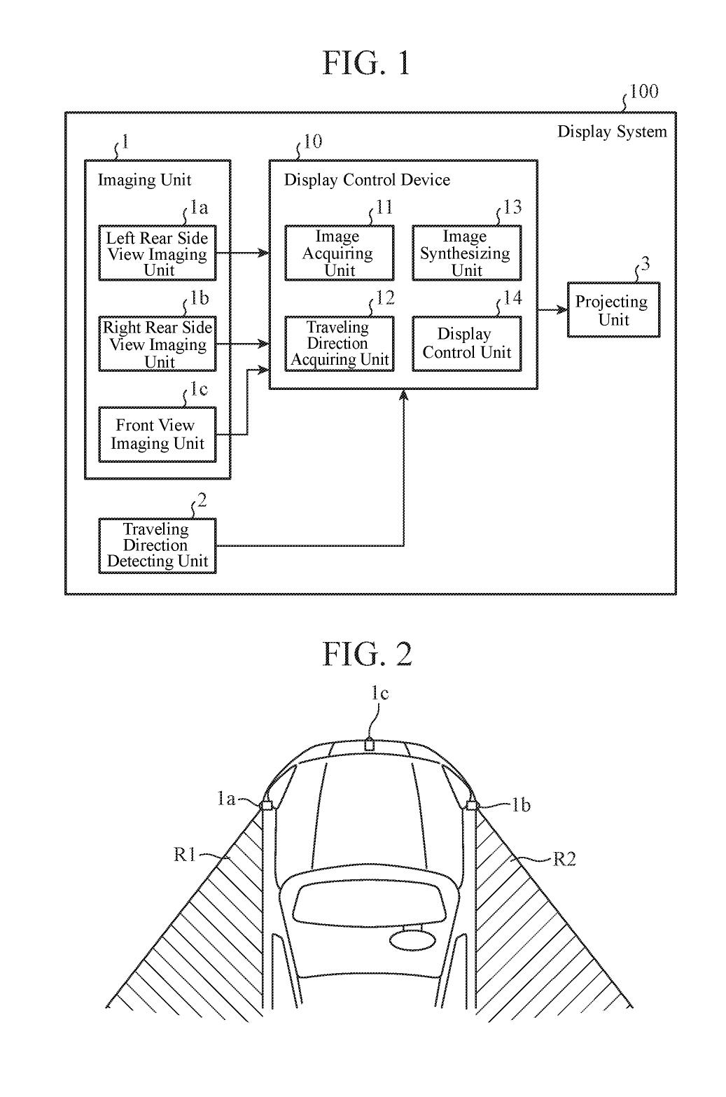

FIG. 1 is a block diagram illustrating a display control device 10 according to a first embodiment of the present invention. FIG. 1 illustrates a case where the display control device 10 is included in an in-vehicle display system 100.

The display system 100 includes an imaging unit 1, a traveling direction detecting unit 2, a projecting unit 3, and the display control device 10.

The imaging unit 1 photographs surroundings of a vehicle. The imaging unit 1 includes a left rear side view imaging unit 1a, a right rear side view imaging unit 1b, and a front view imaging unit 1c.

FIG. 2 is a diagram illustrating exemplary installation of the imaging unit 1. FIG. 2 is a view overlooking the vehicle from above. The left rear side view imaging unit 1a is provided at a position where a left rear side view R1 from the vehicle can be photographed, for example at the left front fender of the vehicle. The right rear side view imaging unit 1b is provided at a position where a right rear side view R2 from the vehicle can be photographed, for example at the right front fender of the vehicle. The front view imaging unit 1c is provided at a position where the front view from the vehicle can be photographed, for example at the edge of the hood of the vehicle. With this configuration, the left rear side view imaging unit 1a is capable of photographing an object present on the left rear side of the vehicle, the right rear side view imaging unit 1b is capable of photographing an object present on the right rear side of the vehicle, and the front view imaging unit 1c is capable of photographing an object present ahead of the vehicle. An object is a thing that a driver is to pay attention to, such as a bicycle, a motorcycle, and a pedestrian.

The imaging unit 1 outputs the images of the surroundings of the vehicle to the display control device 10. In embodiments, the front view, the right rear side view, and the left rear side view from a vehicle are collectively referred to as surroundings of the vehicle. Therefore, the images output from the left rear side view imaging unit 1a, the right rear side view imaging unit 1b, and the front view imaging unit 1c can be referred to as images capturing the surroundings of the vehicle.

The imaging unit 1 includes cameras, and in particular, preferably includes a wide angle camera since the imaging range thereof is wider.

The traveling direction detecting unit 2 detects a change in the traveling direction of the vehicle, such as a right turn, a left turn, and changing lanes. The traveling direction detecting unit 2 detects a change in the traveling direction of the vehicle, for example, by monitoring the state of the direction indicator. Alternatively, the traveling direction detecting unit 2 may detect a change in the traveling direction of the vehicle by monitoring the rotation angle of the steering wheel. For example, when the steering wheel is turned by a set angle or more, the traveling direction detecting unit 2 detects that the traveling direction of the vehicle is to be changed. Alternatively, the traveling direction detecting unit 2 may detect a change in the traveling direction of the vehicle depending on a change in the direction of the line-of-sight of the driver by acquiring the direction of the line-of-sight of the driver from a driver monitoring device that monitors the state of the driver.

When detecting a change in the traveling direction of the vehicle, the traveling direction detecting unit 2 outputs the detection result to the display control device 10 as change information indicating the change in the traveling direction of the vehicle. The change information indicates a direction after the change. For example, in the case where the driver operates the direction indicator to make a left turn, “left” is indicated as a direction after the change in the change information output by the traveling direction detecting unit 2. Moreover, for example in the case where the driver turns the steering wheel to move to a lane on the right, “right” is indicated as a direction after the change in the change information output by the traveling direction detecting unit 2.

The projecting unit 3 is controlled by the display control device 10 to project an image on the windshield of the vehicle. The image projected by the projecting unit 3 and the projection destination are controlled by the display control device 10. The projecting unit 3 is a so-called head up display (HUD). The light source of the projecting unit 3 may be a liquid crystal display (LCD), a laser, an organic electro luminescence (EL), or the like.

The display control device 10 includes an image acquiring unit 11, a traveling direction acquiring unit 12, an image synthesizing unit 13, and a display control unit 14.

The image acquiring unit 11 acquires images capturing the surroundings of the vehicle output from the imaging unit 1. Specifically, the image acquiring unit 11 acquires images photographed by the left rear side view imaging unit 1a, the right rear side view imaging unit 1b, and the front view imaging unit 1c. The image acquiring unit 11 outputs the acquired images to the image synthesizing unit 13.

The traveling direction acquiring unit 12 acquires the change information of the traveling direction of the vehicle output by the traveling direction detecting unit 2. The traveling direction acquiring unit 12 outputs the acquired change information to the image synthesizing unit 13 and the display control unit 14.

The image synthesizing unit 13 synthesizes a plurality of images acquired by the image acquiring unit 11 and outputs the synthesized image to the display control unit 14. Specifically, the image synthesizing unit 13 synthesizes an image capturing the front view from the vehicle and an image capturing, out of the right rear side view and the left rear side view from the vehicle, a rear side view in a direction after a change indicated by the change information. For example, in the case where the change information indicates “left”, the image synthesizing unit 13 synthesizes the image capturing the front view from the vehicle and the image capturing the left rear side view from the vehicle. In the case where the change information indicates “right”, the image synthesizing unit 13 synthesizes the image capturing the front view from the vehicle and the image capturing the right rear side view from the vehicle.

The image capturing the front view from the vehicle is photographed by the front view imaging unit 1c. Likewise, the image capturing the right rear side view from the vehicle is photographed by the right rear side view imaging unit 1b, and the image capturing the left rear side view from the vehicle is photographed by the left rear side view imaging unit 1a.

The display control unit 14 outputs, to the projecting unit 3, a control signal for projecting the image synthesized by the image synthesizing unit 13 in a front view in the direction after the change indicated by the change information out of the right front view and the left front view as viewed from the driver. In the case where the change information indicates “left”, this control signal causes the image to be projected on the left part of the windshield, that is, in the left front view as viewed from the driver. Likewise, in the case where the change information indicates “right”, the image is caused to be projected on the right part of the windshield, that is, in the right front view as viewed from the driver.

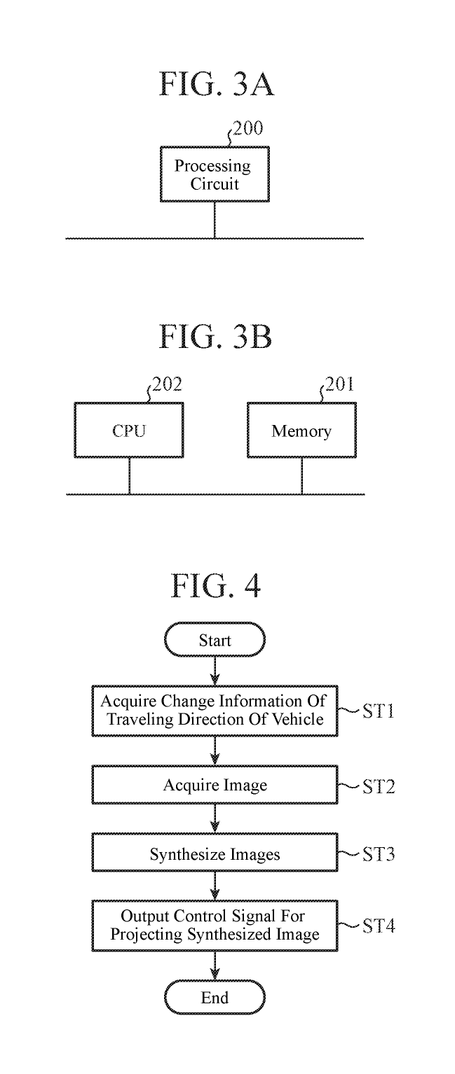

An exemplary hardware configuration of the display control device 10 will be described with reference to FIGS. 3A and 3B.

The functions of the image acquiring unit 11, the traveling direction acquiring unit 12, the image synthesizing unit 13, and the display control unit 14 of the display control device 10 are implemented by a processing circuit. The processing circuit may be dedicated hardware or a central processing unit (CPU) executing a program stored in a memory. The CPU may be referred to as a central processing device, a processing device, an arithmetic device, a microprocessor, a microcomputer, a processor, or a digital signal processor (DSP).

FIG. 3A is a diagram illustrating an exemplary hardware configuration in the case where the functions of the respective units of the display control device 10 are implemented by a processing circuit 200 which is dedicated hardware. The processing circuit 200 corresponds to, for example, a single circuit, a composite circuit, a programmed processor, a parallel programmed processor, an application specific integrated circuit (ASIC), a field-programmable gate array (FPGA), or a combination thereof. The functions of the image acquiring unit 11, the traveling direction acquiring unit 12, the image synthesizing unit 13, and the display control unit 14 may be implemented by combining separate processing circuits 200. Alternatively, the functions of the respective units may be implemented by a single processing circuit 200.

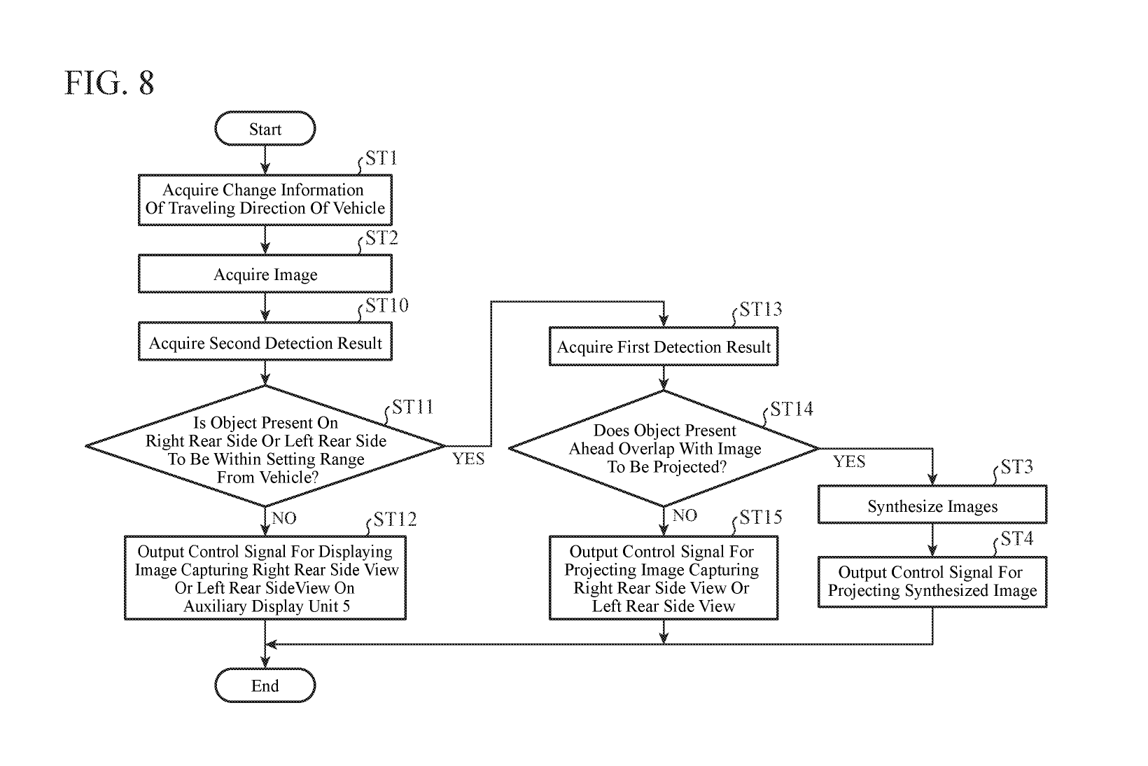

FIG. 3B is a diagram illustrating an exemplary hardware configuration in the case where the functions of the respective units of the display control device 10 are implemented by a CPU 202 for executing a program stored in a memory 201. In this case, the functions of the image acquiring unit 11, the traveling direction acquiring unit 12, the image synthesizing unit 13, and the display control unit 14 are implemented by software, firmware, or a combination of software and firmware. Software and firmware are described as a program and stored in the memory 201. The CPU 202 reads and executes the program stored in the memory 201 to implement the functions of the units of the display control device 10. That is, the display control device 10 has the memory 201 for storing programs and the like which result in execution of processing illustrated in flowcharts of FIGS. 4 and 8 described later. Moreover, it can also be said that these programs cause a computer to execute a procedure or a method which each of the units of the display control device 10 uses. Here, the memory 201 may be a nonvolatile or volatile semiconductor memory, such as a random access memory (RAM), a read only memory (ROM), a flash memory, an erasable programmable ROM (EPROM), and an electrically erasable programmable ROM (EEPROM), a magnetic disc, a flexible disc, an optical disc, a compact disc, a mini disc, a digital versatile disk (DVD), and so on.

Note that a part of the functions of the units of the display control device 10 may be implemented by dedicated hardware, and another part thereof may be implemented by software or firmware. For example, the functions of the image acquiring unit 11 and the traveling direction acquiring unit 12 may be implemented by a processing circuit as dedicated hardware, and the functions of the image synthesizing unit 13 and the display control unit 14 may be implemented by a processing circuit reading and executing a program stored in a memory.

In this manner, the processing circuit can implement the functions of the display control device 10 described above by hardware, software, firmware, or a combination thereof.

Moreover, the traveling direction detecting unit 2 can also be configured as illustrated in FIGS. 3A and 3B like the display control device 10.

Next, exemplary processing performed by the display control device 10 configured as described above will be described with reference to the flowchart illustrated in FIG. 4.

When the driver operates the direction indicator or the like, the traveling direction acquiring unit 12 acquires change information of the traveling direction of the vehicle from the traveling direction detecting unit 2 (step ST1). The acquired change information is output to the image synthesizing unit 13 and the display control unit 14.

Then, the image acquiring unit 11 acquires images capturing the surroundings of the vehicle from the imaging unit 1 (step ST2). The acquired images are output to the image synthesizing unit 13.

Subsequently, the image synthesizing unit 13 synthesizes an image capturing the front view from the vehicle and an image capturing, out of the right rear side view and the left rear side view from the vehicle, a rear side view in a direction after the change indicated by the change information (step ST3). The synthesized image is output to the display control unit 14.

Subsequently, the display control unit 14 outputs, to the projecting unit 3, a control signal for projecting the image synthesized by the image synthesizing unit 13 in the front view in the direction after the change indicated by the change information out of the right front view and the left front view as viewed from the driver (step ST4). Upon receiving this control signal, the projecting unit 3 projects the synthesized image in the right front view or the left front view as viewed from the driver. When the change information indicates “left”, the image is projected on the left part of the windshield. Alternatively, when the change information indicates “right”, the image is projected on the right part of the windshield.

The above processing in steps ST1 to ST4 is repeatedly performed each time the traveling direction detecting unit 2 detects a change in the traveling direction of the vehicle.

Note that the image acquiring unit 11 may acquire the change information from the traveling direction acquiring unit 12 and output only the image capturing a rear side view in the direction after the change indicated by the change information and an image capturing the front view from the vehicle to the image synthesizing unit 13.

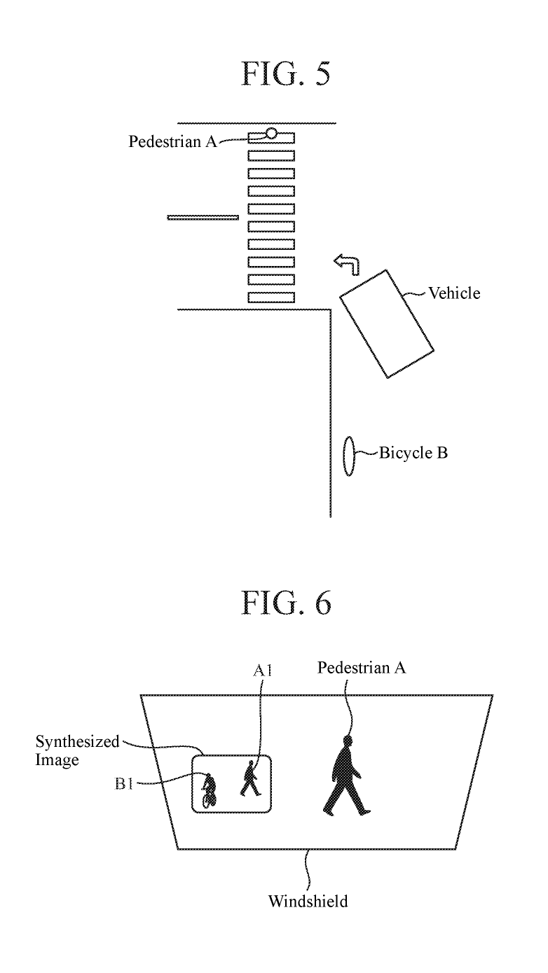

FIG. 5 is an overhead view illustrating an example of the vehicle and surroundings thereof. The vehicle makes a left turn while changing the traveling direction to the left. In this case, a pedestrian A is present ahead of the vehicle and a bicycle B is present on the left rear side of the vehicle.

An image projected by the projecting unit 3 under the situation illustrated in FIG. 5 is illustrated in FIG. 6. Since the traveling direction is changed to the left, a synthesized image, in which an image capturing the left rear side view from the vehicle and an image capturing the front view from the vehicle are synthesized, is projected on the left part of the windshield, that is, in the left front view as viewed from the driver. In the synthesized image, an image A1 of the pedestrian A present ahead of the vehicle and an image B1 of the bicycle B present on the left rear side of the vehicle are captured.

In this manner, since the image capturing the right rear side view or the left rear side view from the vehicle is projected in the right front view or the left front view as viewed from the driver, the driver can confirm the right rear side view or the left rear side view from the vehicle without a large amount of movement of the line of sight when turning to the left or the right and when changing lines. In addition, since the image capturing the front view from the vehicle is also synthesized at this time, it is possible to simultaneously confirm the front view from the vehicle as well.

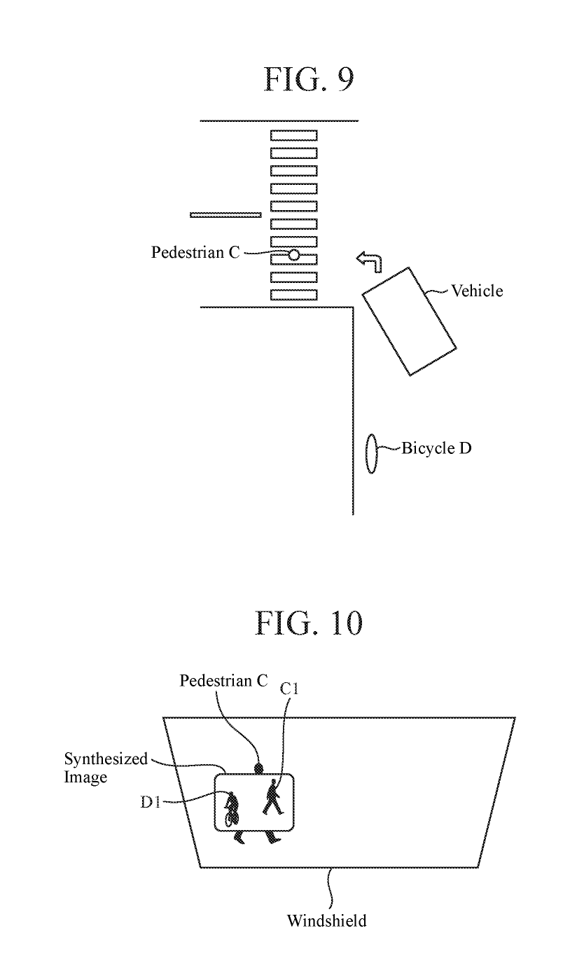

Note that, in the case illustrated in FIGS. 5 and 6, the projected image and the pedestrian A present ahead do not overlap when viewed from the driver. On the other hand, as illustrated in FIGS. 9 and 10 which will be described later, there is a case where the projected image and the pedestrian A present ahead overlap when viewed from the driver. In this case, the driver cannot directly confirm the pedestrian A through the windshield since the pedestrian A is hidden by the projected image. However, even when such overlapping occurs, since the image capturing the front view from the vehicle is synthesized and projected, the driver watching the image can recognize the presence of the pedestrian A. Of course, even in the case where no overlapping occurs as illustrated in FIGS. 5 and 6, the driver is provided with two means of confirming the pedestrian A, which are direct confirmation through the windshield and indirect confirmation by the projected image. Thus, the driver can achieve secure confirmation.

Note that, in the above description, the projecting unit 3 projects the image on the windshield. However, one combiner may be provided in each of the right front view and the left front view as viewed from the driver, and the projecting unit 3 may project the image on one of the combiners. For example at the time of turning to the right, an image is projected on the combiner provided in the right front view as viewed from the driver under control of the display control device 10, and for example at the time of turning to the left, an image is projected on the combiner provided in the left front view as viewed from the driver under control of the display control device 10.

Moreover, in the above description, the case where the display control device 10 is provided in the in-vehicle display system 100 has been described. However, each of units included in the display control device 10, such as the image acquiring unit 11, the traveling direction acquiring unit 12, the image synthesizing unit 13, and the display control unit 14, may be provided in an external server, and the control of the projecting unit 3 may be performed remotely with the external server transmitting and receiving information to and from the imaging unit 1, the traveling direction detecting unit 2, and the projecting unit 3. In this case, the imaging unit 1, the traveling direction detecting unit 2, and the projecting unit 3 may be connected to the external server via a mobile terminal, such as a smartphone, to allow communication therebetween, thus allowing transmission and reception of information between the imaging unit 1, the traveling direction detecting unit 2, and the projecting unit 3 and the external server.

Furthermore, each of units included in the display control device 10, such as the image acquiring unit 11, the traveling direction acquiring unit 12, the image synthesizing unit 13, and the display control unit 14, may be provided in a mobile terminal to allow the mobile terminal to function as the display control device 10.

As described above, according to the display control device 10 of the first embodiment, an image obtained by synthesizing an image capturing the front view from the vehicle and an image capturing the right rear side view or the right rear side view from the vehicle is projected in the right front view or the left front view as viewed from the driver. Therefore, the driver can confirm the right rear side view or the left rear side view from the vehicle without a large amount of movement of the line of sight and confirm the front view from the vehicle as well.

In addition, the left rear side view imaging unit 1a and the right rear side view imaging unit 1b are provided at the left front fender and the right front fender of the vehicle to photograph the left rear side view and the right rear side view from the vehicle, respectively. With this configuration, as compared with the case where the right rear side view imaging unit 1b and the left rear side view imaging unit 1a are provided at the door mirror positions to photograph the right rear side view and the left rear side view from the vehicle, blind areas can be reduced which are not included in the imaging ranges of the right rear side view imaging unit 1b and the left rear side view imaging unit 1a on the right rear side and the left rear side of the vehicle.

In addition, the front view imaging unit 1c is provided at the edge of the hood of the vehicle to photograph the front view from the vehicle. With this configuration, as compared with the case where the front view imaging unit 1c is provided at an upper part of the windshield, that is, next to the rear-view mirror to photograph the front view from the vehicle, a blind area can be reduced which is not included in the imaging range of the front view imaging unit 1c in front of the vehicle.

In addition, the imaging unit 1 includes a wide angle camera. Using a wide angle camera can reduce a blind area that is not included in the imaging range of the imaging unit 1.

### Second Embodiment

In the first embodiment, the case where the image capturing the front view from the vehicle and the image capturing the right rear side view or the right rear side view from the vehicle are synthesized and projected has been described. A second embodiment describes the case where such synthesis and projection are performed only when a specific condition is satisfied.

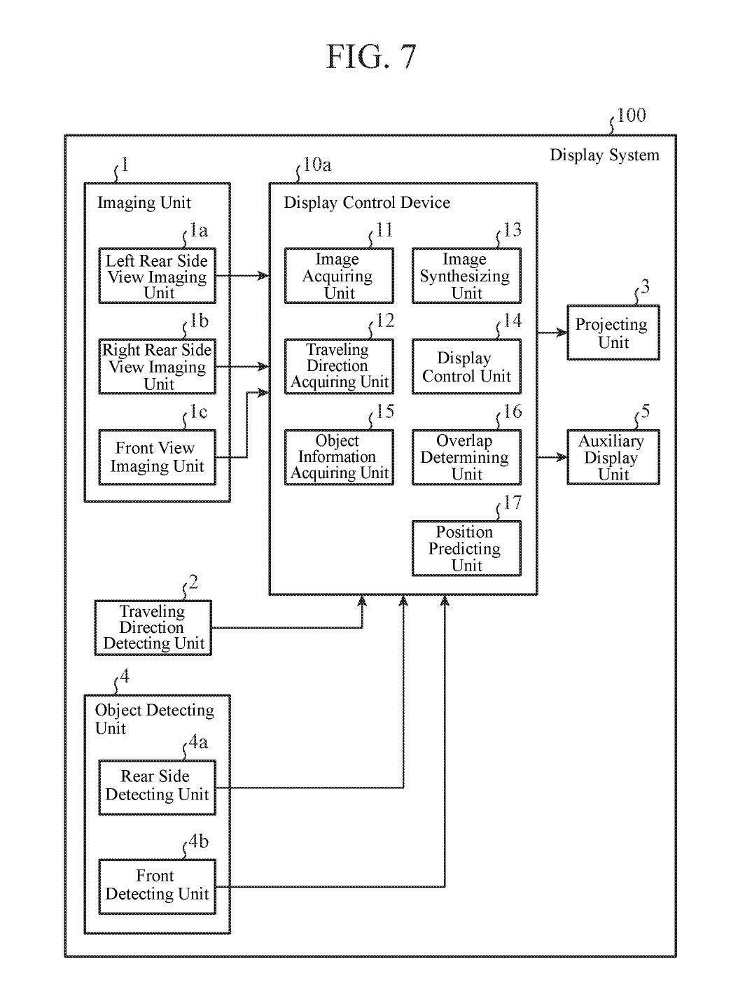

FIG. 7 is a block diagram illustrating a display control device 10a according to the second embodiment of the present invention. FIG. 7 illustrates a case where the display control device 10a is included in a display system 100. Note that the same reference numerals are given to components having the same functions as or corresponding functions to those of components already described in the first embodiment, and description thereof will be omitted or simplified.

The display system 100 further includes an object detecting unit 4 and an auxiliary display unit 5 in addition to an imaging unit 1, a traveling direction detecting unit 2, a projecting unit 3, and a display control device 10a.

The object detecting unit 4 generates information on objects present around a vehicle. Specifically, the object detecting unit 4 detects the position of an object present ahead of the vehicle. The detected position indicates the relative position with respect to the vehicle, that is, in which direction and how far away from the vehicle. The object detecting unit 4 outputs a first detection result indicating the position of the detected object present in front of the vehicle to the display control device 10a.

The object detecting unit 4 also detects the traveling direction, the velocity, and the position of an object present on the right rear side or the left rear side of the vehicle. The object detecting unit 4 outputs, to the display control device 10a, a second detection result indicating the traveling direction, the velocity, and the position of the detected object present on the right rear side or the left rear side of the vehicle.

The object detecting unit 4 includes a rear side detecting unit 4a for detecting an object present on the right rear side or the left rear side of the vehicle and a front detecting unit 4b for detecting an object present ahead of the vehicle.

The rear side detecting unit 4a and the front detecting unit 4b are, for example, millimeter wave radars. The rear side detecting unit 4a is provided at a position where an object present on the right rear side or the left rear side of the vehicle can be detected, for example, at the rear bumper. The front detecting unit 4b is provided at a position where an object present ahead of the vehicle can be detected, for example, at the front bumper.

The rear side detecting unit 4a and the front detecting unit 4b may be image recognition devices that acquire images photographed by the imaging unit 1 and detect the position and the like of an object by image processing. Alternatively, a stereo camera may be provided exclusively for the object detecting unit 4, and images photographed by the stereo camera may be subjected to image processing. Further alternatively, the object detecting unit 4 may be configured by a combination of a millimeter wave radar and an image recognition device. Furthermore, the object detecting unit 4 may detect the size of an object by image processing and include the size in a detection result.

The auxiliary display unit 5 is controlled by the display control device 10a to display an image. The image displayed by the auxiliary display unit 5 is controlled by the display control device 10a. The auxiliary display unit 5 is, for example, an instrument panel or a center information display (CID). Alternatively, a dedicated display device may be provided as the auxiliary display unit 5.

The display control device 10a includes an object information acquiring unit 15, an overlap determining unit 16, and a position predicting unit 17 in addition to an image acquiring unit 11, a traveling direction acquiring unit 12, an image synthesizing unit 13, and a display control unit 14.

The object information acquiring unit 15 acquires the first detection result and the second detection result output from the object detecting unit 4, outputs the first detection result to the overlap determining unit 16, and outputs the second detection result to the position predicting unit 17.

The overlap determining unit 16 determines, by using the position of an object present ahead of the vehicle indicated by the first detection result, whether the object and an image to be projected by the projecting unit 3 overlap with each other as viewed from a driver. In the case of overlapping, the object present ahead of the vehicle is to be hidden by the image to be projected by the projecting unit 3. Thus, the driver cannot confirm the object through the windshield. Note that the range within which the projecting unit 3 projects an image is prestored in a memory (not illustrated) in the display control device 10a. The overlap determining unit 16 reads from the memory the range in the case of projecting in the front view in the direction after a change indicated by change information out of the right front view and the left front view as viewed from the driver. Then, the overlap determining unit 16 performs the determination.

The overlap determining unit 16 outputs the determination result to the image synthesizing unit 13 and the display control unit 14.

The position predicting unit 17 predicts, by using the traveling direction, the velocity, and the position of an object present on the right rear side or the left rear side of the vehicle indicated by the second detection result, the positional relationship between the vehicle and the object at a time when the vehicle changes the traveling direction. Then, in the predicted positional relationship, the position predicting unit 17 determines whether the object is away from the vehicle by a setting range. The setting range is set to a value at which collision may occur, for example.

The position predicting unit 17 outputs the determination result to the image synthesizing unit 13 and the display control unit 14.

For example, let us assume that a driver intends to turn to the left at an intersection and operates a direction indicator before the intersection. In this case, a change in the traveling direction of the vehicle is detected by the traveling direction detecting unit 2, and the object detecting unit 4 detects the position, the traveling direction, and the velocity of an object present on the right rear side or the left rear side of the vehicle. The position predicting unit 17 acquires the current position of the vehicle, map information corresponding to an area around the vehicle, a planned traveling route, and the like from a navigation device (not illustrated) as well as the velocity of the vehicle from a vehicle speed sensor (not illustrated). Then, the position predicting unit 17 uses these pieces of information to calculate an intersection at which the vehicle is to make a turn to the left and when the vehicle reaches the intersection. Then, the position predicting unit 17 uses the position, the traveling direction, the velocity, and the like of the object detected by the object detecting unit 4 to calculate where the object reaches when the vehicle reaches the intersection. For example in the above manner, the position predicting unit 17 can predict the positional relationship between the vehicle and the object at a time when the vehicle turns to the left at the intersection.

The display control device 10a according to the second embodiment can be configured as illustrated in FIG. 3A and FIG. 3B like in the display control device 10 of the first embodiment.

Next, exemplary processing performed by the display control device 10a of the second embodiment configured as described above will be described with reference to the flowchart illustrated in FIG. 8. Steps in which the same or equivalent processing as or to the processing already described with reference to FIG. 4 is performed are denoted by the same reference numerals, and description thereof will be omitted or simplified.

Change information acquired in step ST1 is output to the image synthesizing unit 13, the display control unit 14, the overlap determining unit 16, and the position predicting unit 17.

Moreover, images acquired in step ST2 are output to the image synthesizing unit 13.

Subsequent to step ST2, the object information acquiring unit 15 acquires the second detection result (step ST10). The acquired second detection result is output to the position predicting unit 17.

Subsequently, the position predicting unit 17 predicts, by using the second detection result, the positional relationship between the vehicle and an object at a time when the vehicle changes the traveling direction. The object is an object present on a rear side in the direction after the change indicated by the change information. Then, the position predicting unit 17 determines whether the object is predicted to be present within the setting range from the vehicle when the vehicle changes the traveling direction (step ST11). The determination result is output to the image synthesizing unit 13, the display control unit 14, and the object information acquiring unit 15.

If it is not predicted that the object is to be present within the setting range, that is, if it is predicted that the object is to be present outside the setting range (step ST11; NO), the image synthesizing unit 13 outputs, to the display control unit 14, an image capturing, out of the right rear side view and the left rear side view from the vehicle, a rear side view in the direction after the change indicated by the change information. Then, the display control unit 14 outputs a control signal for displaying the image on the auxiliary display unit 5 (step ST12). As a result, the auxiliary display unit 5 displays an image capturing, out of the right rear side view and the left rear side view from the vehicle, a rear side view in a direction after the change indicated by the change information.

In this manner, by displaying the image on the auxiliary display unit 5 without projection by the projecting unit 3, the field of view of the driver is not blocked more than necessary. In addition, in the case where the driver wishes to confirm the right rear side view or the left rear side view from the vehicle for assurance, it is enough to look at the display on the auxiliary display unit 5.

Note that, the case where no object is present on a rear side in the direction after the change indicated by the change information is regarded as the case where an object is predicted to be present outside the setting range.

On the other hand, if it is predicted that the object is to be present within the setting range (step ST11; YES), the object information acquiring unit 15 acquires the first detection result (step ST13). The acquired first detection result is output to the overlap determining unit 16.

Subsequently, the overlap determining unit 16 uses the first detection result to determine whether the object present ahead of the vehicle and an image to be projected by the projecting unit 3 overlap with each other as viewed from the driver (step ST14). The determination result is output to the image synthesizing unit 13 and the display control unit 14.

If the overlap determining unit 16 determines that no overlapping occurs (step ST14; NO), the image synthesizing unit 13 outputs, to the display control unit 14, an image capturing, out of the right rear side view and the left rear side view from the vehicle, a rear side view in the direction after the change indicated by the change information. Then, the display control unit 14 outputs, to the projecting unit 3, a control signal for projecting the image in the front view in the direction after the change indicated by the change information out of the right front view and the left front view as viewed from the driver (step ST15).

Note that, the case where no object is present in front of the vehicle is regarded as the case where it is determined that no overlapping occurs.

On the other hand, if it is determined by the overlap determining unit 16 that the overlapping occurs (step ST14; YES), the processing in steps ST3 and ST4 is performed. As a result, an image, which is obtained by synthesizing the image capturing the front view from the vehicle and an image capturing, out of the right rear side view and the left rear side view from the vehicle, a rear side view in the direction after the change indicated by the change information, is projected in a front view in the direction after the change indicated by the change information out of the right front view and the left front view as viewed from the driver.

The above processing in steps ST1 to ST15 is performed repeatedly each time the traveling direction detecting unit 2 detects a change in the traveling direction of the vehicle.

FIG. 9 is an overhead view illustrating an example of the vehicle and surroundings thereof. The vehicle makes a left turn while changing the traveling direction to the left. In this case, a pedestrian C is present ahead of the vehicle and a bicycle D is present on the left rear side of the vehicle. The bicycle D is present within the setting range from the vehicle.

An image projected by the projecting unit 3 under the situation illustrated in FIG. 9 is illustrated in FIG. 10. Since the traveling direction is changed to the left, a synthesized image, in which an image capturing the left rear side view from the vehicle and an image capturing the front view from the vehicle are synthesized, is projected on the left part of the windshield, that is, in the left front view as viewed from the driver. In the synthesized image, an image C1 of the pedestrian C present ahead of the vehicle and an image D1 of the bicycle D present on the left rear side of the vehicle are captured.

As illustrated in FIG. 10, the projected image and the pedestrian C present ahead overlap when viewed from the driver. In this case, the driver cannot directly confirm the pedestrian C through the windshield since the pedestrian C is hidden by the projected image. However, since the image capturing the front view from the vehicle is synthesized and projected, the driver watching the image can recognize the presence of the pedestrian C.

In this manner, since the image capturing the right rear side view or the left rear side view from the vehicle is projected in the right front view or the left front view as viewed from the driver, the driver can confirm the right rear side view or the left rear side view from the vehicle without a large amount of movement of the line of sight when turning to the left or the right and when changing lines. In addition, since the image capturing the front view from the vehicle is also synthesized at this time, it is possible to simultaneously confirm the front view from the vehicle as well.

Note that in the above description, the position predicting unit 17 determines whether an object is present within the setting range from the vehicle in a predicted positional relationship. However, the position predicting unit 17 may perform the determination without predicting the positional relationship but on the basis of whether the position of the object indicated by the second detection result is within the setting range from the vehicle at that time.

Moreover, the image synthesizing unit 13 may synthesize images so that an object present ahead of the vehicle and the object in the image capturing the front view from the vehicle overlap with each other when viewed from the driver.

Furthermore, the display control unit 14 may also output, to the auxiliary display unit 5, a control signal for displaying the image obtained by synthesizing the image capturing the front view from the vehicle and an image capturing, out of the right rear side view and the left rear side view from the vehicle, a rear side view in the direction after the change indicated by the change information.

Let us further assume that after the image has been projected in step ST4, the positional relationship between the vehicle and an object present on the right rear side, on the left rear side, or in front of the vehicle changes, and as a result of this the image projected by the projecting unit 3 no longer overlaps with the object present ahead of the vehicle. In this case, the display control unit 14 controls the projecting unit 3 so that an image capturing, out of the right rear side view and the left rear side view from the vehicle, a rear side view in the direction after the change indicated by the change information is projected instead of the synthesized image.

In contrast, let us assume that after the image has been projected in step ST15, the positional relationship between the vehicle and the object present on the right rear side, on the left rear side, or in front of the vehicle changes, and as a result of this the image projected by the projecting unit 3 overlaps with the object present ahead of the vehicle. In this case, the display control unit 14 controls the projecting unit 3 so that a synthesized image obtained by synthesizing an image capturing the front view from the vehicle and an image capturing, out of the right rear side view and the left rear side view from the vehicle, a rear side view in the direction after the change indicated by the change information is projected.

The display control device 10a may be configured so that the position predicting unit 17 is not included, that is, the determination processing in step ST11 is not performed. In this case, the display control device 10a synthesizes images when the overlap determining unit 16 determines that overlap occurs, and the display control device 10a does not synthesize images when the overlap determining unit 16 determines that overlap does not occur.

As described above, according to the display control device 10a of the second embodiment, effects similar to those of the first embodiment can be obtained. In addition, it is convenient for the driver that an image is displayed on the auxiliary display unit 5 or an image in which an image capturing the front view from the vehicle is not synthesized is projected depending on the situation.

Moreover, the position predicting unit 17 for predicting the positional relationship between the vehicle and an object present on the right rear side or the left rear side of the vehicle is provided, the object information acquiring unit 15 acquires the second detection result indicating a detection result of the traveling direction, the velocity, and the position of the object, the position predicting unit 17 uses the second detection result to predict the positional relationship between the vehicle and the object at a time when the vehicle changes the traveling direction, and the display control unit 14 outputs a control signal when it is predicted that the object is to be present within the setting range from the vehicle. This configuration allows control which reflects the situation where an object is present within the setting range to be performed, thus further enhancing the convenience for the driver.

Moreover, the position predicting unit 17 for predicting the positional relationship between the vehicle and an object present on the right rear side or the left rear side of the vehicle is provided, the object information acquiring unit 15 acquires the second detection result indicating a detection result of the traveling direction, the velocity, and the position of the object, the position predicting unit 17 uses the second detection result to predict the positional relationship between the vehicle and the object at a time when the vehicle changes the traveling direction, and the display control unit 14 does not output a control signal when it is predicted that the object is to be present outside the setting range from the vehicle. This configuration allows control which reflects the situation where an object is present outside the setting range to be performed, thus further enhancing the convenience for the driver.

Furthermore, the display control unit 14 outputs a control signal for causing the auxiliary display unit 5 to display an image capturing, out of the right rear side view and the left rear side view from the vehicle, a rear side view in a direction after the change indicated by the change information. With this configuration, the field of view of the driver is not blocked more than necessary. In addition, in the case where the driver wishes to confirm the right rear side view or the left rear side view from the vehicle for assurance, it is enough to look at the display on the auxiliary display unit 5.

In addition, the object detecting unit 4 performs detection using the image capturing the front view from the vehicle. It is preferable, in terms of the number of parts, that images obtained by the imaging unit 1 are used not only for projection but also for processing performed by the object detecting unit 4.

Note that, within the scope of the present invention, the present invention may include a flexible combination of the embodiments, a modification of any component of the embodiments, or an omission of any component in the embodiments.

### INDUSTRIAL APPLICABILITY

As described above, the display control device according to the present invention allows a driver to confirm the right rear side view or the left rear side view from a vehicle without a large amount of movement of the line of sight and to confirm the front view from the vehicle as well, and thus is suitable for use as a thing incorporated into a display system which provides useful images for driving to the driver by displaying the images.

### REFERENCE SIGNS LIST

1: Imaging unit, 1a: Left rear side view imaging unit, 1b: Right rear side view imaging unit, 1c: Front view imaging unit, 2: Traveling direction detecting unit, 3: Projecting unit, 4: Object detecting unit, 4a: Rear side detecting unit, 4b: Front detecting unit, 5: Auxiliary display unit, 10, 10a: Display control device, 11: Image acquiring unit, 12: Traveling direction acquiring unit, 13: Image synthesizing unit, 14: Display control unit, 15: Object information acquiring unit, 16: Overlap determining unit, 17: Position predicting unit, 100: Display system, 200: Processing circuit, 201: Memory, 202: CPU

1.-11. (canceled)

12. A display control device comprising:
a processor to execute a program; and
a memory to store the program which, when executed by the processor, performs processes of, acquiring images capturing surroundings of a vehicle;
acquiring change information of a traveling direction of the vehicle;
acquiring a first detection result indicating a detection result of a position of an object present ahead of the vehicle;
determining whether the object and a projected image or an image to be projected overlap when viewed from a driver by using the first detection result;
synthesizing an image capturing a front view from the vehicle and an image capturing a rear side view in a direction after a change indicated by the change information in a case where it is determined that overlap occurs, the rear side view being one of a right rear side view and a left rear side view from the vehicle; and
outputting a control signal for projecting an image synthesized in a front view in the direction after the change indicated by the change information, the front view being one of a right front view and a left front view as viewed from the driver.

13. The display control device according to claim 12,
wherein the processes further include acquiring a second detection result indicating a detection result of a traveling direction, a velocity, and a position of an object, the object being present on a right rear side or a left rear side of the vehicle, and
predicting a positional relationship between the vehicle and the object at a time when the vehicle changes a traveling direction by using the second detection result, and
in a case where it is predicted that the object is to be present within a setting range from the vehicle, the control signal is output.

14. The display control device according to claim 12,
wherein the processes further include acquiring a second detection result indicating a detection result of a traveling direction, a velocity, and a position of an object, the object being present on a right rear side or a left rear side of the vehicle, and
predicting a positional relationship between the vehicle and the object at a time when the vehicle changes a traveling direction by using the second detection result, and
in a case where it is predicted that the object is to be present outside a setting range from the vehicle, the control signal is not output.

15. The display control device according to claim 14, wherein the processes further include outputting a control signal for causing an auxiliary display to display the image capturing the rear side view in the direction after the change indicated by the change information, the rear side view being one of the right rear side view and the left rear side view from the vehicle.

16. A display system comprising:
the display control device according to claim 12;
cameras to photograph the surroundings of the vehicle;
a traveling direction detector to detect the change in the traveling direction of the vehicle;
a projector to project an image under control of the display control device; and
an object detector to detect the position of the object present ahead of the vehicle,
wherein the object detector performs detection using the image capturing the front view from the vehicle.

17. The display system according to claim 16, wherein the cameras include a camera provided at a left front fender of the vehicle and a camera provided at a right front fender of the vehicle to photograph the right rear side view and the left rear side view from the vehicle.

18. The display system according to claim 16, wherein the cameras include a camera provided at an edge of a hood of the vehicle to photograph the front view from the vehicle.

19. The display system according to claim 16, wherein the cameras include a wide angle camera.

20. A display control method comprising:
acquiring images capturing surroundings of a vehicle;
acquiring change information of a traveling direction of the vehicle;
acquiring a first detection result indicating a detection result of a position of an object present ahead of the vehicle;
determining whether the object and a projected image or an image to be projected overlap when viewed from a driver by using the first detection result;
synthesizing an image capturing a front view from the vehicle and an image capturing a rear side view in a direction after a change indicated by the change information in a case where it is determined that overlap occurs, the rear side view being one of a right rear side view and a left rear side view from the vehicle; and
outputting a control signal for projecting an image synthesized in a front view in the direction after the change indicated by the change information, the front view being one of a right front view and a left front view as viewed from the driver.
